(19) United States
(12) Patent Application Publication
(10) Pub. No.: US 2009/0288481 A1
(43) Pub. Date: Nov. 26, 2009

(54) TEMPERATURE SENSOR

(75) Inventors: Jan-Willem Burssens Urssens, Tessenderlo (BE); Ewald Vermeulen, Tessenderlo (BE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: EPIQ Sensor-Nite NV, Tessenderlo (BE)

(21) Appl. No.: 12/208,210

(22) Filed: Sep. 10, 2008

(30) Foreign Application Priority Data
Sep. 14, 2007 (GB) 0717994.8

(51) Int. Cl. G01F 1/69

(52) U.S. Cl. 73/204.27

(57) ABSTRACT

A sensor having a temperature dependent resistor mounted within a protective housing. The resistor is connected to external circuitry via a pair of connecting wires. In use, variations in temperature of the exhaust gas cause a variation in the temperature experienced by the resistor and consequently, the resistance of the resistor also varies. The resistor is mounted in a projecting end portion of the housing which is of narrower cross-section than the bulk of the housing. The housing is filled with a filler material. The filler material provides support to the resistor and the wires. In the present invention, unlike in prior art sensors, the filler material does not completely fill the housing. Instead a gap is provided which is crossed by the wires. The gap interrupts heat flow through the filler material and thus improves the thermal isolation of the resistor and thereby the accuracy of the sensor. In an alternative embodiment, the sensor additionally comprises an additional heat exchange element. The provision of the additional heat exchange element improves the flow of heat from the exhaust gas to the resistor, thus providing a faster response when the temperature rapidly changes and higher measurement accuracy.

### CROSS-REFERENCES TO RELATED APPLICATIONS

This application claims priority to UK 0717994.8, filed Sep. 14, 2007, which is hereby incorporated by reference in its entirety for all purposes.

### BACKGROUND

The present invention relates to a temperature sensor, and in particular to a temperature sensor suitable for monitoring the temperature of gas in a vehicle exhaust system.

In many vehicles the temperature of the exhaust gases is monitored to provide feedback on engine operation. A typical exhaust temperature sensor comprises a temperature dependant resistor element, which is provided within a protective housing. The housing is mounted such that it projects into the exhaust gas flow, with the resistor being mounted at the tip of the housing projecting furthest into the exhaust. An indication of the temperature is obtained by monitoring the resistance of the resistor. This monitoring is facilitated by the provision of a pair of wires running within the housing to connect the resistor to external circuitry. To provide support to the wires and (to some extent) the walls of the housing, the housing is filled with a filler material, typically a compacted powder.

An accurate temperature measurement is difficult to obtain because of the low heat capacity of gas and its low heat conductivity. This problem is exacerbated when the insertion depth of the sensor in to the gas flow is relatively short, which may be necessary to avoid impeding gas flow or to maintain the structural integrity of the housing. Errors in measurement are also compounded by the heat flow through the housing to the exterior of the exhaust, which is normally at a lower temperature.

The heat flow problem has been addressed in current sensor designs by reducing the cross-section of the housing, increasing the insertion depth into the exhaust flow and using filler materials having relatively low thermal conductivity. None of these proposals adequately solve the heat flow problem.

It is therefore desirable to provide a temperature sensor that at least partly alleviates or overcomes the above problems.

### BRIEF SUMMARY

According to a first aspect there is provided a temperature sensor, suitable for use in a vehicle exhaust, the sensor comprising: a temperature dependent resistor; a pair of connection wires facilitating connection of the resistor to the external circuitry; a housing in which the resistor is mounted and through which the wires run from the resistor to an exit point; and filler material provided within the housing to support the wires and/or housing wherein there is a gap in the filler material across which the wires run, the gap being provided between the resistor and the exit point.

The gap impedes the heat flow through the filler material and thus provides thermal decoupling between the resistor and the exterior of the exhaust. This improves the level of accuracy achievable by the sensor.

Preferably, the filler material is a fine grained refractory castable material. This material may be hardened within the housing. Examples of suitable materials include phosphate bonded materials, calcium aluminates or magnesium oxysulfate bonded materials. Such a material provides the necessary level of support for the connecting wires. In contrast, conventional compacted powder filler materials will not provide sufficient support to the connecting wires in the presence of normal mechanical forces such as vibration.

The housing may be formed from any suitable material including but not limited to stainless steel or nickel base alloys. The housing may have a substantially circular cross-section. The resistor is preferably mounted in a projecting end portion of the housing. The projecting end portion may also be of substantially circular cross-section but is preferably of narrower cross-section than the rest of the housing. By having a narrower cross-section heat flow between the exterior of the projecting portion and the resistor is improved.

The sensor may be adapted to be fitted in a hole provided in an exhaust wall. The sensor may be provided with a suitable mounting means for retaining the sensor within the hole. The mounting means may comprise a flange. Alternatively other suitable forms of mounting means may be used such as clamping devices or press fitting.

The exit point for the wires is preferably in a rear portion of the housing beyond the mounting means. The wires may be provided with an insulating sheath.

In order to achieve a better heat transfer from the gas to the temperature sensor an additional heat exchange element may be attached to the housing. The additional heat exchange element may be attached to the housing adjacent to the position where the resistor is mounted. The additional heat exchange element may be a plate providing a large contact surface projecting into the exhaust gas. Such a plate will enable increased heat flow form the exhaust gas to the resistor and hence improve the performance of the sensor. The plate may be provided with one or more surface features or ridges adapted to further increase its surface area. The additional heat exchange element may be formed from metal or other material with good heat conductivity.

According to a second aspect there is provided a temperature sensor, suitable for use in a vehicle exhaust, the sensor comprising: a temperature dependent resistor; a pair of connection wires facilitating connection of the resistor to the external circuitry; a housing within which the resistor is mounted and the wires run; and a filler material provided within the housing to support the wires and/or housing wherein an additional heat exchange element is provided upon the portion of the housing within which the resistor is mounted.

The provision of the additional heat exchange element increases the flow of heat from the exhaust gas to the resistor. The increased heat flow from gas to resistor provides a faster response when the exhaust gas temperature rapidly changes and higher measurement accuracy amongst other benefits thus improving the performance of the sensor.

The sensor of the second aspect may incorporate any or all features of the first aspect of the present invention as desired or as appropriate.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

In order that the invention can be more clearly understood it is now described further below with reference to the accompanying drawings:

FIG. 1 is a schematic diagram of a first embodiment of a temperature sensor; and

FIG. 2 is a schematic diagram of a second embodiment of a temperature sensor.

### DETAILED DESCRIPTION OF THE INVENTION

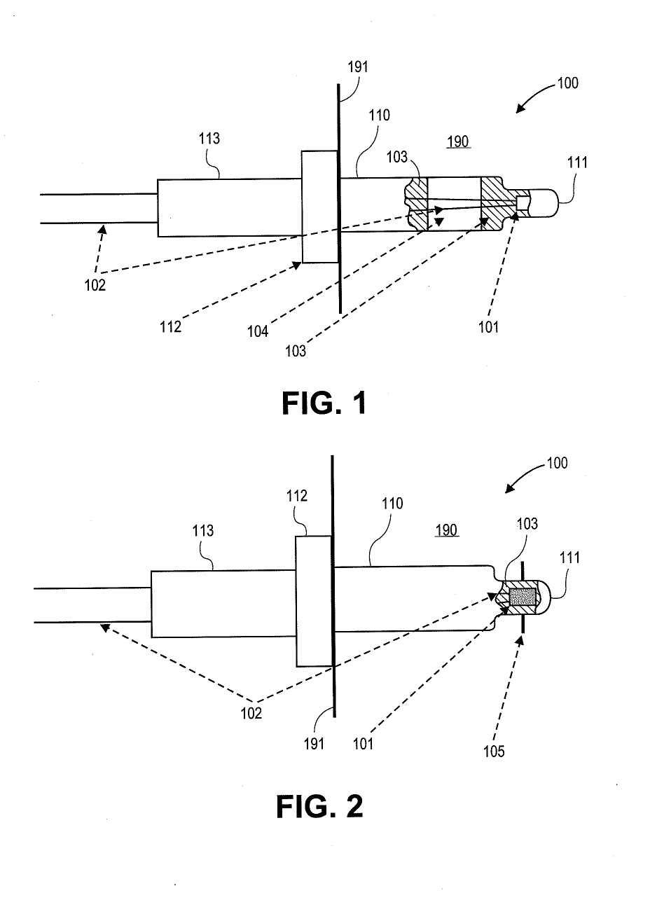

Referring now to FIG. 1, a temperature sensor 100 projects into an exhaust pipe 190 of a vehicle through a specially provided hole (not shown) in pipe wall 191. The wall 191 divides a hot zone within the pipe 190 from a cold zone exterior to the pipe 190.

The sensor 100 includes a temperature dependent resistor 101 mounted within a protective housing 110. The housing 110 is formed from materials such as stainless steel, nickel base alloys or similar materials. The resistor 101 is connected to external circuitry via a pair of connecting wires 102. In use, variations in temperature of the exhaust gas cause a variation in the temperature experienced by the resistor 101. Consequently, the resistance of the resistor 101 also varies. The resistance variation can be monitored by external circuitry via the wires 102 so as to provide an indication of the exhaust gas temperature.

The resistor 101 is mounted in a projecting end portion 111 of the housing which is of narrower cross-section than the bulk of the housing 110. This exposes the resistor 101 more directly to the gas flow and thus improves the heat flow between the resistor 101 and the exhaust gas. The improved heat flow improves the accuracy and response time of the sensor 100.

The housing 110 is retained in position by mounting means 112, which may include a flange or any other suitable means. Typically, as is shown in the figure, the sensor may have a rear portion 113 extending beyond the mounting means 112. In some embodiments, the rear portion 113 may house circuitry for monitoring the variation in resistance of the resistor 101.

In one embodiment, the housing 110 is filled with a filler material 103. The filler material 103 provides support to the resistor 101 and the wires 102. Unlike in prior art sensors, the filler material does not completely fill the housing 110. Instead a gap 104 is provided which is crossed by the wires 102. The gap 104 interrupts heat flow through the filler material and thus improves the thermal isolation of the resistor 101 and thereby the accuracy of the sensor 100.

In one embodiment, the filler material 103 is a refractory castable material such as a phosphate bonded material, a calcium aluminate or magnesium oxysulfate bonded material. Such a material provides support to the wires 102 despite the presence of the gap 104. Conventional compacted powder filler material does not provide sufficient support.

Turning now to FIG. 2, there is provided an alternative embodiment of a temperature sensor 100. The sensor of FIG. 2 may incorporate all the features of the sensor of FIG. 1. Accordingly, like reference numerals have been used for like components and the description above of the general form of the sensor 100 of FIG. 1, will suffice to describe the general form of the sensor 100 of FIG. 2. One skilled in the art will of course understand that the sensor 100 of FIG. 2 need not incorporate all features of the sensor 100 of FIG. 1. For instance, in some embodiments, the sensor 100 of FIG. 2, may have a housing 110 substantially filled with compacted powder filler material 103, rather than the refractory castable filler material 103 having a gap 104.

The embodiment of FIG. 2 is distinguished from that of FIG. 1 by the provision of an additional heat exchange element 105. The provision of the additional heat exchange element 105 improves the flow of heat from the exhaust gas to the resistor 101, thus providing a faster response when the temperature rapidly changes and higher measurement accuracy. The additional heat exchange element 105 shown is in the form of a simple plate but more complex elements can be used incorporating additional ridges and/or other structures to increase the surface area of the element 105 in contact with the gas. Typically, the heat exchange element is formed from a material having high heat conductivity, such as a metal.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A temperature sensor, suitable for use in a vehicle exhaust, the sensor comprising:
a temperature dependent resistor;
a pair of connection wires facilitating connection of the resistor to external circuitry;
a housing in which the resistor is mounted and through which the wires run from the resistor to an exit point; and
filler material provided within the housing to support the wires and/or housing wherein there is a gap in the filler material across which the wires run, the gap being provided between the resistor and the exit point.

2. A temperature sensor as claimed in claim 1 wherein the filler material is a fine grained refractory castable material hardened within the housing.

3. A temperature sensor as claimed in claim 1 wherein the housing has a substantially circular cross-section with a projecting end portion of the housing of narrower substantially circular cross-section than the rest of the housing and wherein the resistor is mounted in the projecting end portion of the housing.

4. A temperature sensor as claimed in claim 1 wherein the sensor is adapted to be fitted in a hole provided in an exhaust wall and is provided with a flange, a clamping device or a press fitting for retaining the sensor within the hole.

5. A temperature sensor as claimed in claim 1 further including a heat exchange element attached to the housing adjacent to the position where the resistor is mounted.

6. A temperature sensor as claimed in claim 5 wherein the heat exchange element includes a plate providing a large contact surface projecting into the exhaust gas.

7. A temperature sensor as claimed in claim 6 wherein the plate is provided with one or more surface features or ridges adapted to further increase its surface area.

8. A temperature sensor, suitable for use in a vehicle exhaust, the sensor comprising:
a temperature dependent resistor;
a pair of connection wires facilitating connection of the resistor to external circuitry;
a housing within which the resistor is mounted and the wires run;
a filler material provided within the housing to support the wires and/or housing; and
a heat exchange element attached to a portion of the housing within which the resistor is mounted.

9. A temperature sensor as claimed in claim 8 wherein the heat exchange element includes a plate providing a large contact surface projecting into the exhaust gas.

10. A temperature sensor as claimed in claim 9 wherein the plate is provided with one or more surface features or ridges adapted to further increase its surface area.

11. A temperature sensor as claimed in claim 8 wherein the heat exchange element is formed from metal or other material with good heat conductivity.

12. A temperature sensor as claimed in claim 8 wherein the filler material is a fine grained refractory castable material that is hardened within the housing.

13. A temperature sensor as claimed in claim 8 wherein the housing has a substantially circular cross-section with a projecting end portion of the housing of narrower substantially circular cross-section than the rest of the housing and wherein the resistor is mounted in the projecting end portion of the housing.

14. A temperature sensor as claimed in claim 8 wherein the sensor is adapted to be fitted in a hole provided in an exhaust wall and is provided with a flange, a clamping device or a press fitting for retaining the sensor within the hole.
